(19) United States
(12) Patent Application Publication
(10) Pub. No.: US 2015/0298500 A1
(43) Pub. Date: Oct. 22, 2015

(54) Bicycle Wheel with Interchangeable Aerodynamic Shells

(71) Applicant: Zachary Alex McCormick, Chattanooga, TN (US)

(72) Inventor: Zachary Alex McCormick, Chattanooga, TN (US)

(21) Appl. No.: 14/691,699

(22) Filed: Apr. 21, 2015

Related U.S. Application Data
(60) Provisional application No. 61/995,772, filed on Apr. 21, 2014.

(51) Int. Cl. B60B 7/01; B60B 1/02; B60B 7/00; B60B 1/00

(52) U.S. Cl. CPC B60B 7/01; B60B 1/003; B60B 1/02; B60B 7/0006; B60B 2900/1216; B60Y 2200/13

(57) ABSTRACT

A bicycle wheel is described that features interchangeable aerodynamic shells. These interchangeable shells allow for adjustment of the radial width of a bicycle rim. In one embodiment, these shells have magnets attached to them that allow the shells to be attached to and removed from a wheel quickly and easily, thereby allowing someone to easily change their shells for shells of a different radial width.

### CROSS-REFERENCE TO RELATED APPLICATIONS

This application claims the benefit of US provisional application 61/995,772, filed on Apr. 21, 2014.

### BACKGROUND OF THE INVENTION

Aerodynamic bicycle wheels have been used for many years in the cycling industry. One of the main factors that contributes to the aerodynamic characteristics of a bicycle wheel is the radial width of the rim. (This radial width is generally called “depth,” so depth will be used rather than “radial width” hereafter.) Deeper rims are generally more aerodynamic (that is, they create less aerodynamic drag) than shallower rims. Bicycle wheels with deep rims are advantageous because they create less wind resistance than traditional wheels, which allows the cyclist to go faster with the same effort. Wheels with deep rims have two main disadvantages, though. First, they are generally heavier than traditional wheels. This makes them less appropriate for hilly courses, where the weight of the bicycle is an important factor in cycling speed. Secondly, wheels with deep rims make the bicycle more difficult to handle in crosswinds, because they have more lateral surface area than shallower wheels, and thus wind coming from the side of the bicycle creates a larger side force.

The relative importance of these advantages and disadvantages depends on the characteristics of the riding conditions. On a flat course without much wind, wheels with deep rims are ideal because the decrease in aerodynamic drag outweighs both the increase in weight and the decrease in crosswind stability. On hilly or windy courses, though, a shallower rim is advantageous because of the reduction in weight and the increase in crosswind stability, respectively. Therefore, it is common practice for cyclists to own multiple sets of bicycle wheels, where the primary difference between the different sets of wheels is the radial depth of the rim. This allows the cyclist to choose a set of wheels appropriate for the conditions of each specific ride or race. The main disadvantage of this approach is the cost of purchasing multiple sets of wheels.

One common type of aerodynamic bicycle wheel consists of a non-structural aerodynamic shell permanently bonded to a load-bearing rim.

### DESCRIPTION OF THE FIRST EMBODIMENT

Looking at FIG. 1, a bicycle wheel consists of a rim 1, a hub 2, and a plurality of spokes 3, with each spoke tensioned between the hub and the rim. The bicycle wheel of FIG. 1 does not contain any aerodynamic shells. A wheel as shown in FIG. 1 will hereafter be referred to as a “base wheel.”

Looking at FIG. 2, an aerodynamic shell 4a (hereafter, shell) has attached to it one or more adapter pieces 5a. These adapter pieces are shaped such that one side of the adapter piece can smoothly fit up against the inside of the shell. Each adapter piece contains a flat side that is oriented perpendicular to the central axis of rotation of the shell. This flat side contains a recess in which a magnet 6a fits.

Each shell has small slots or holes cut into the inner radius of the shell so that the shell can fit around the spokes when placed on the rim. The slots or holes should be of sufficient size to fit around the spokes, but they should not be unnecessarily large.

Looking at FIGS. 4 and 5, two shells 4a and 4b can be attached to a base wheel such that the radial outer edges of the shells fit against the rim of the base wheel. Each magnet of one shell comes into sufficient proximity of a magnet of the other shell, so that they provide a magnetic pulling force between the two shells. A magnet of one shell could physically touch a magnet of another shell, or there could be a small distance between them.

The size, material, placement, and number of magnets should be chosen such that this magnetic force between the two shells is high enough to keep the shells from detaching from one another during normal bicycle riding conditions. But this force should not be so high that the shells cannot be removed by pulling them apart. This specific embodiment uses ten neodymium magnets on each shell, with the magnets approximately 1″×0.25″×0.125″ in size, but many other combinations of size, material, placement, and number of magnets could also work, and this specific combination should by no means be seen as a statement limiting the scope of the present invention.

Also note that other embodiments could use an attachment means other than magnets. Magnets are one of a multitude of possible methods of attachment for the shells. Other possible attachment methods contemplated include screws, snap closures, hook-and-loop closures, post screws, and tape, among others. Also, in other embodiments, the shells could be attached to the rim rather than to each other.

To attach the shells onto the base wheel, one need only to hold one shell in each hand, and, with the base wheel on the ground (and off the bike), hold the shells up against the rim such that the spoke holes are lined up with the spokes. When the shells come sufficiently close to each other, the magnetic pulling force between them will cause them to snap together. To remove the shells, one just needs to grab one shell in each hand and pull them apart.

Note that in this embodiment, the shells do not attach directly to the rim, but rather to each other. The shells are sized such that when they are attached to each other, with one shell on each side of a base wheel, they come into contact with the rim and/or the spokes. This contact with the rim and/or spokes is sufficient to keep them in place while they are being used on a bicycle.

### BRIEF DESCRIPTIONS OF THE DRAWINGS

FIG. 1 shows a base wheel with a rim 1, a hub 2, and spokes 3.

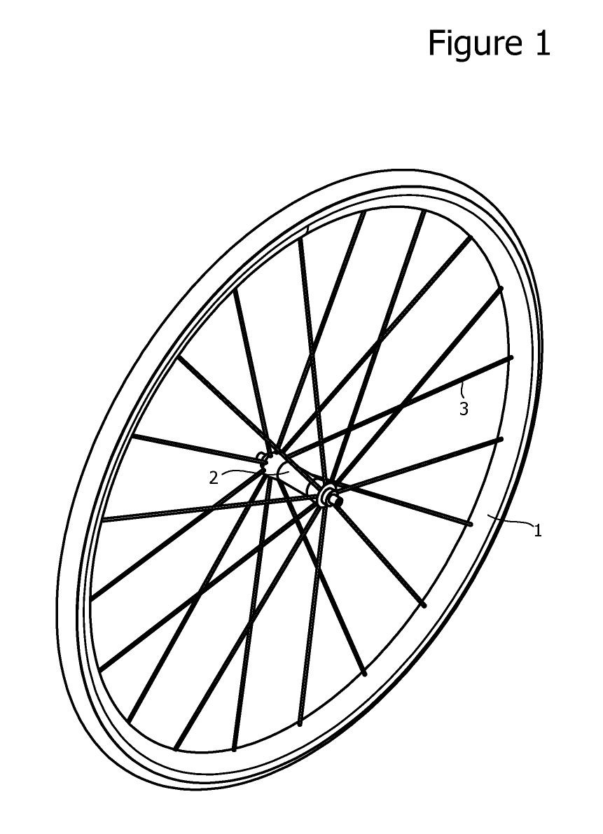

FIG. 2 shows a shell 4a with an adapter piece 5a and a magnet 6a.

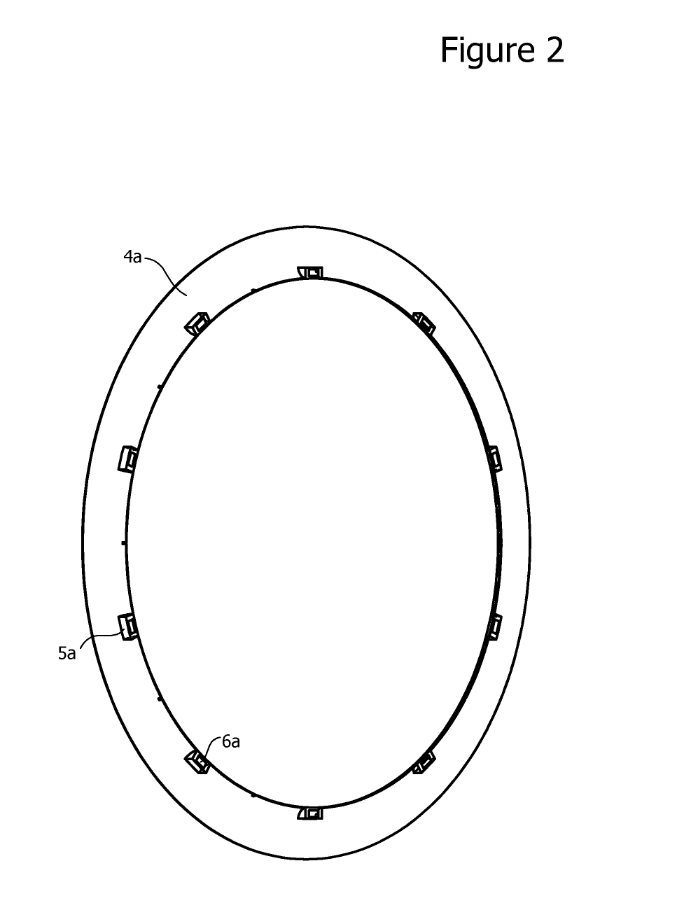

FIG. 3 shows a cross-sectional view of tho shells 4a and 4b in their attached position.

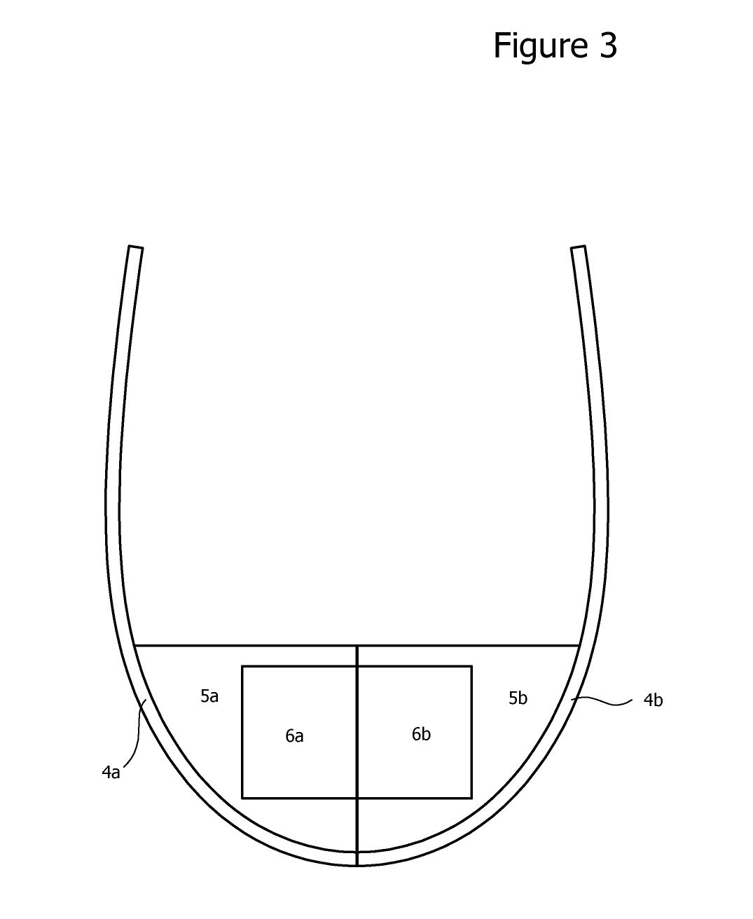

FIG. 4 shows two shells 4a and 4b in an unattached position around a base wheel.

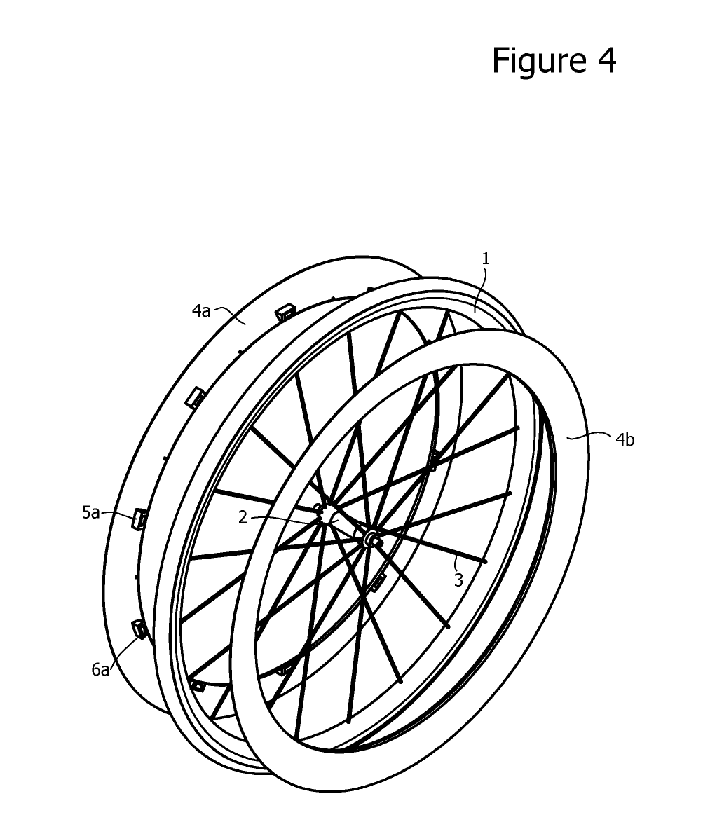

FIG. 5 shows two shells in their attached position on the base wheel.

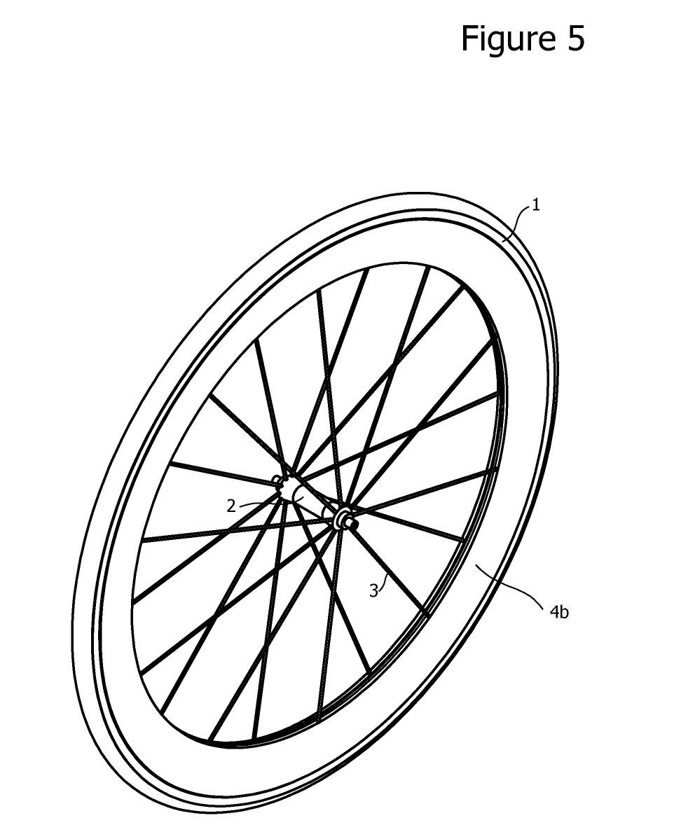

I claim:

1. A bicycle wheel comprising:
a hub, a rim containing a structure for receiving and retaining a tire, a plurality of spokes tensioned between said hub and said rim, and one or more pairs of aerodynamic shells with means for attachment to and removal from said rim and/or said spokes.
